(19) United States
(12) Patent Application Publication
(10) Pub. No.: US 2005/0023716 A1
(43) Pub. Date: Feb. 3, 2005

(54) Method for restoring surfaces of injection molded parts

(76) Inventor: Russell D. Jenkins, Northville, MI (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/631,397

(22) Filed: Jul. 31, 2003

(51) Int. Cl. B32B 31/00; B24B 1/00

(52) U.S. Cl. 264/138; 264/162; 264/129

(57) ABSTRACT

A method for restoring the finish of injection molded parts includes the steps of scuffing a surface of an unrestored injection molded plastic part with a scuff pad formed of an abrasive material, cleaning the scuffed surface with a cleaner substance, applying a base coat material to the scuffed and cleaned surface, applying a finish coat material over the base coat material on the surface, and blending the base coat material and the finish coat material with a cloth member to produce a desired appearance for the surface.

### BACKGROUND OF THE INVENTION

The present invention relates generally to the restoration of plastic automotive parts and, in particular, to a method for restoring such parts.

Injection molded parts are well known. The automotive industry in particular has been utilizing these parts for many years to decrease the weight and price of certain vehicular components including, but not limited to, air intake systems and the like. A popular hobby is the restoration of automobiles, especially classic automobiles. This hobby has spawned an industry of businesses that specialize in restoring cars and the original parts for these cars. The hobbyists and the industry conduct competitions to determine which of the vehicles have been restored most accurately, including details such as correct color shades and the number of original parts utilized, among others.

A common problem associated with restoring vehicles is the finish on the exterior surfaces of vehicle interior and engine compartment injection molded parts including, but not limited to, air grabbers, fan shrouds, heater boxes, and the like. When new, these injection molded parts often have a metallic or a satin-like appearance due to the injection molding process. After many years, however, these parts lose their original appearance and disadvantageously appear flat and discolored. In restoration competitions, those individuals involved in restoring vehicles may lose points in competition as a result of poor or unrestored finish, or finish not nearly complete as the original finish on the injection molded parts. In addition, not many of these injection parts are produced as reproduction items.

It is desirable, therefore, to restore these factory-original parts of the vehicles to their original “factory-new” appearance and condition. It is also desirable to provide a method for restoring the finish of injection molded parts.

### SUMMARY OF THE INVENTION

A method for restoring the finish of injection molded parts includes the steps of scuffing a surface of an unrestored injection molded plastic part with a scuff pad formed of an abrasive material, cleaning the scuffed surface with a cleaner substance, applying a base coat material to the scuffed and cleaned surface, applying a finish coat material over the base coat material on the surface, and blending the base coat material and the finish coat material with a cloth member to produce a desired appearance for the surface.

The system and method in accordance with the present invention will provide an effective system and method for restoring the finish of the surfaces of injection molded parts.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a finish restoring kit in accordance with the present invention;

FIG. 2 is a perspective view of a plastic part having a surface to be refinished in accordance with the present invention;

FIG. 3 is a perspective view of a cloth member used with the kit shown in FIG. 1;

FIG. 4 is an enlarged fragmentary sectional view of the part of FIG. 1 showing first and second layers of a coating according to the present invention;

FIG. 5 is a view of the part of FIG. 4 showing the first and second layers blended; and

FIG. 6 is a flowchart of the steps of a method in accordance with the present invention.

### DESCRIPTION OF THE PREFERRED EMBODIMENT

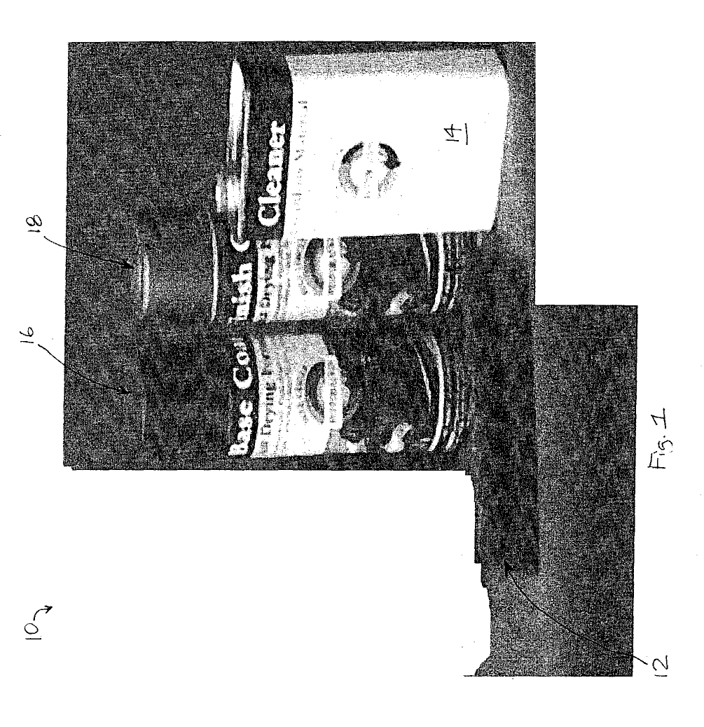

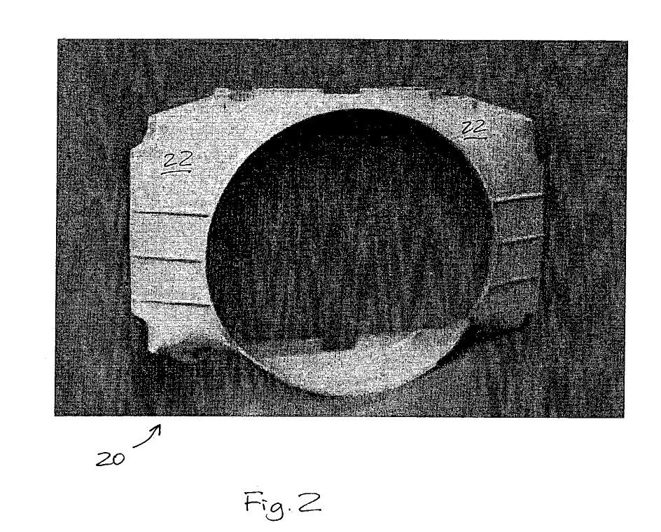

Referring now to FIG. 1, a kit in accordance with the present invention is indicated generally at 10. The kit 10 includes at least one abrasive scuff pad 12, a container 14 of liquid cleaner substance, a first paint coating applicator 16, and a second paint coating applicator 18. The kit 10 is used for restoring the finish of an exterior surface 22 of an injection molded part 20, such as a fan shroud shown in FIG. 2. Alternatively, the part 20 is an air grabber (not shown), a heater box (not shown), or any other plastic part where it is desirable to restore the finish of the exterior surface thereof.

The at least one abrasive scuff pad 12 is preferably formed of an abrasive material including, but not limited to, Scotch-Brite® abrasive hand pads, available commercially from the 3M Corporation. The coarseness of an exterior surface of the scuff pad 12 is operable to abrade the exterior surface 22 of the part 20 to prepare the surface 22 for the paint coating, discussed in more detail below. Preferably, the coarseness of the scuff pad 12 is less than that of a steel wool or similar material.

The cleaner container 14 preferably contains a commercially available lacquer thinner, such as, but not limited to, Klean-Strip® automotive surface preparation thinner available from the W.M. Barr Company, Inc. Such a cleaner substance is suitable for cleaning and degreasing the surface 22.

The first paint coating applicator 16 is preferably adapted to dispense a fast drying acrylic enamel paint material having a flat finish, discussed in more detail below, such as a paint applicator and material commercially available from Seymour of Sycamore, Inc. Similarly, the second paint coating applicator 18 is preferably adapted to dispense a fast drying acrylic enamel paint material having a gray cast metallic finish, discussed in more detail below, such as a paint applicator and material commercially available from Seymour of Sycamore, Inc.

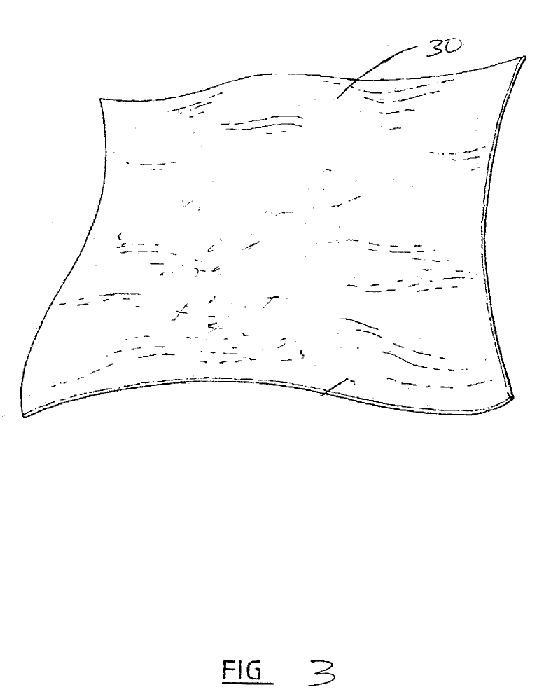

Referring now to FIG. 3, a cloth member 30 is preferably a shop rag or similar type natural fabric member. Alternatively, the cloth member 30 is formed of a lint-free material or a synthetic material.

In operation, the surface 22 of the part 20 is cleaned by using a detergent and hot water solution (not shown). The detergent may be any type of detergent including, but not limited to, Tide®, or a dishwashing detergent. After cleaning with the detergent and after the surface 22 has dried sufficiently, the scuff pad 12 is utilized to abrade the surface 22 of the part 20, which prepares the surface 22 to accept and adhere to the paint dispensed from the applicators 16 and 18.

After the scuff pad 12 has been used to abrade the surface 22, the lacquer thinner of the cleaner container 14 is utilized to remove any debris, petroleum products such as grease, or the like from the surface 22. The lacquer thinner of the cleaner container 14 may be applied to the surface 22 utilizing a cloth member, such as the cloth member 30 of FIG. 3, or by any other type of cleaning device. After cleaning, the surface 22 is allowed to dry.

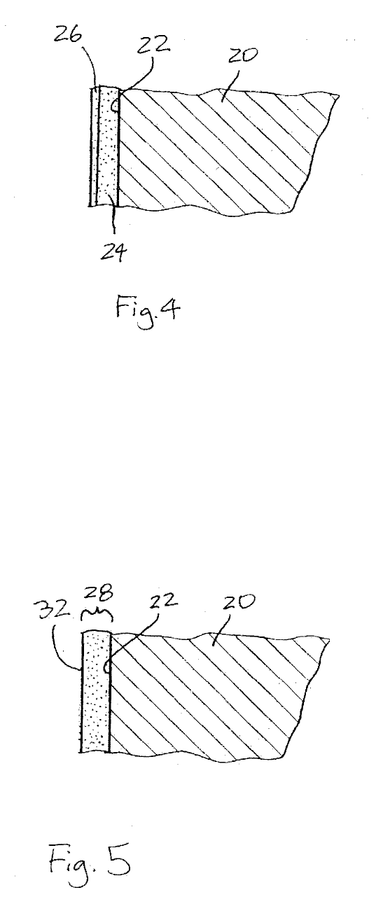

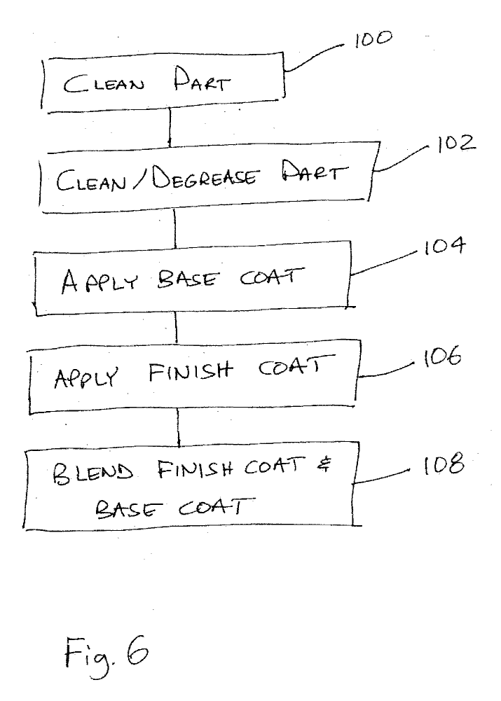

Referring now to FIGS. 4 and 5, the part 20 is shown in partial cross section. In FIG. 4, a first paint material 24, dispensed from the first paint coating applicator 16, is disposed on the surface 22 after the surface 22 and the lacquer thinner of the cleaner container 14 has dried sufficiently. Preferably, the first paint material 24 has a flat finish appearance when dry. The first paint material 24 is applied to the surface 22 to form a relatively thick layer on the surface 22, best seen in FIG. 4. The first paint material 24 is allowed to dry, after which a second paint material 26 is dispensed from the second paint coating applicator 18 to adhere to the flat finish first paint material 24. Preferably, the second paint material 26 has a satin/metallic finish appearance when dry. The second paint material 26 is applied to the first paint material 24 in a layer that is thinner than the layer of the first paint material 24, best seen in FIG. 4. During application, the second paint material 26 is preferably misted onto the first paint material 24 and allowed to at least partially dry.

After the second paint material 26 has at least partially dried, a blending member, such as the cloth member 30 of FIG. 3, is utilized to blend the first paint material 24 and the second 26 paint material. When blended with the blending member, the first paint material 24 and the second paint material 26 form a coating layer 28 having a resulting exterior surface 32, best seen in FIG. 5. The first paint material 24 and the second paint material 26 are blended until the coating surface 32 has the desired appearance. Preferably, the desired appearance of the exterior surface 32 of the coating layer 28 is a combination of the flat finish of the first paint material 24 and the satin/metallic finish of the second paint material 26. Preferably, the exterior surface 32 is visually similar to the finish of the exterior surface 22 of the part 20 when new. The second paint material 26 of the second paint applicator 18 may be misted onto the coating surface 32 at least once more and blended further in order to produce the desired visual appearance of the surface 32.

Referring now to FIG. 6, a flowchart is shown that describes in detail how a method in accordance with the present invention may be practiced. In a step 100, the part, such as the fan shroud 20 of FIG. 2, is cleaned with a detergent. In a step 102, the part is cleaned and degreased, such as with the lacquer thinner of the cleaner in the container 14 of FIG. 1. In a step 104, a base coat, such as the first paint material 24 from the first paint applicator 16, is applied to the exterior surface of the part. In a step 106, a finish coat, such as the second paint material 26 from the second paint applicator 18, is applied to the base coat. In a step 108, the finish coat and the base coat are blended, such as by the use of the cloth member 30 of FIG. 3.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A method for restoring a finish of a surface of a part formed of a plastic material, comprising the steps of:
a) scuffing a surface of an unrestored injection molded plastic part with a scuff pad formed of an abrasive material;
b) cleaning the scuffed surface with a cleaner substance;
c) applying a base coat material to the scuffed and cleaned surface;
d) applying a finish coat material over the base coat material on the surface; and
e) blending the base coat material and the finish coat material with a cloth member to produce a desired appearance for the surface.

2. The method according to claim 1 including, prior to said step a), cleaning the surface of the part with a detergent solution.

3. The method according to claim 1 wherein the base coat material is a flat finish paint.

4. The method according to claim 1 wherein the finish coat material is a metallic finish paint.

5. The method according to claim 1 wherein the step d) is performed by lightly misting the finish coat material onto the surface.

6. The method according to claim 1 wherein said step e) is performed until the desired appearance resembles a finish of the part when new.

7. The method according to claim 1 including, after said step e), repeating said steps d) and e) at least one time.

8. A method for restoring a finish of a surface of a part formed of a plastic material, comprising the steps of:
a) providing a scuff pad formed of an abrasive material;
b) scuffing a surface of an unrestored injection molded plastic part with the scuff pad;
c) providing a cleaner substance;
d) cleaning the scuffed surface with the cleaner substance;
e) providing a first paint coating applicator containing a base coat material;
f) applying the base coat material to the scuffed and cleaned surface with the first paint coating applicator;
g) providing a second paint coating applicator containing a finish coat material;
h) applying the finish coat material over the base coat material on the surface with the second paint coating applicator;
i) providing a cloth member; and
j) blending the base coat material and the finish coat material with the cloth member to produce a desired appearance for the surface.

9. The method according to claim 8 including, prior to said step b), cleaning the surface of the part with a detergent solution.

10. The method according to claim 8 wherein the base coat material is a flat finish paint.

11. The method according to claim 8 wherein the finish coat material is a metallic finish paint.

12. The method according to claim 8 wherein the step h) is performed by lightly misting the finish coat material onto the surface.

13. The method according to claim 8 wherein said step j) is performed until the desired appearance resembles a finish of the part when new.

14. The method according to claim 8 including, after said step j), repeating said steps h) and j) at least one time.

15. A system for restoring a surface of an unrestored plastic part, comprising:
a scuff pad formed of an abrasive material adapted for scuffing a surface of a plastic part;
a cleaner substance adapted for cleaning the surface after scuffing with said scuff pad;
a first paint coating applicator containing a base coat material and adapted for applying said base coat material to the scuffed and cleaned surface; and
a second paint coating applicator containing a finish coat material and adapted for applying said finish coat material over said base coat material on the surface.
